(19) United States
(12) Patent Application Publication
(10) Pub. No.: US 2006/0210806 A1
(43) Pub. Date: Sep. 21, 2006

(54) Methods and compositions for dielectric materials

(76) Inventor: Kevin G. Nelson, West Pittston, PA (US)

Correspondence Address: TROUTMAN SANDERS LLP, 600 PEACHTREE STREET , NE, ATLANTA, GA, 30308, US

(21) Appl. No.: 11/334,947

(22) Filed: Jan. 19, 2006

Related U.S. Application Data
(60) Provisional application No. 60/644,976, filed on Jan. 19, 2005.

(51) Int. Cl. B32B 27/00; B27J 5/00

(52) U.S. Cl. 428/422; 264/127

(57) ABSTRACT

The present invention comprises methods and compositions of dielectric materials. The dielectric materials of the present invention comprise materials having a dielectric constant of more than 1.0 and less than 1.9, or a dissipation factor of less than 0.0009, or a material having a dielectric constant of more than 1.0 and less than 1.9, and a dissipation factor of less than 0.0009. Other characteristics include the ability to withstand a wide range of temperatures, from both high temperatures of approximately +260° C. to low temperatures of approximately −200° C., operate in wide range of atmospheric conditions and pressures, such as a high atmosphere, low vacuum such as found in outer space as well as at sea level or below sea level, and is used in the manufacture of composite structures that can be used alone or in combination with other materials, and can be used in electronic components or devices.

### FIELD OF INVENTION

The present invention is directed to dielectric materials and methods of making and using such materials, particularly in laminate articles and assemblies comprising at least one dielectric material, for circuit boards, insulators, radar microwave and other applications.

### BACKGROUND OF THE INVENTION

Composite or laminate structures are the basis for many applications in the electronics industry. Advances in printed wiring board laminates have lead to faster, smaller, lighter and cost effective electronic components for use in applications such as radar, antennas, telephony, computer board components, wireless and cellular technology, and microwave devices. The characteristics of the materials used to make the composites effect the technical abilities and applications for which the composite or laminate structure can be used.

A variety of composite structures are used in the electronics industry. Technical requirements for such composites include the structural integrity of the finished structure, the ability of the individual components to withstand the rigors of assembly, the ability of the assembled structure to withstand a variety of processing conditions, such as those used in making printed wired circuit boards, the performance properties of the components used and the finished structure including the dielectric constant, resistance to environmental conditions such as moisture, atmosphere, harsh chemicals, and heat; costs of the components, and costs associated with the manufacture of the finished article.

One component of a laminate is the dielectric material that is used. A dielectric is an insulating material that does not conduct electrons easily and thus has the ability to store electrical energy when a potential difference exists across it. The stored energy is known as an electric potential or an electrostatic field which holds electrons. The electrons are discharged when the buildup of electrons is sufficiently large. Common dielectric materials include glass, mica, mineral oil, paper, paraffin, polystyrene, phenolics, aramids and porcelain. The characteristics of the dielectric are determined by the material from which it is made and its thickness.

In electronic circuits, dielectric materials may be employed in capacitors and as circuit board substrates. Conventionally, dielectric constant materials are used in radar or microwave applications and also for circuit miniaturization as the speed of propagation of signal at a constant frequency is proportional to the inverse of the square root of the dielectric constant of the medium through which it passes. Low dielectric constant materials are used for high speed, low loss transmission of signals as such materials allow faster signal propagation, and less space is required in circuitry design or in conductive layers. Low dielectric materials also have radar and microwave applications. If the combination of materials is such that the loss tangent for a material of a given frequency signal is very low, the circuit board will allow very efficient transmission or splitting of the signal without electrical loss related to the hysteresis loop. If a whole circuit were built on low dielectric material, one could amplify the signal only a certain amount at each mounted transistor because of the power involved which would build up excessive heat and temperature. Consequently, the amplification was spread over a large space. If all of the dielectric material had a high dielectric constant, there would be more loss at signal splits so that more transistors would be necessary to maintain a specific signal to noise ratio.

One of the common materials used in the production of printed circuit boards, which are used in antennas and other elements of cellular and wireless technology is glass fiber and/or woven glass materials that are coated with PTFE (polytetrafluoroethylene), cyanate ester, aramids, and/or PTFE films. This material has been used because it can be manufactured readily, but it is expensive, it requires multiple steps to manufacture, and it is relatively heavy due to its density of about 2.5, and it is limited to dielectric constants no lower than about 2.17.

Efforts have been made to provide materials that are lighter and have lower dielectric constants. Such efforts include making a structure in which a microballoon-filled adhesive is used to bond metal foil directly to a rigid polyisocyanurate foam. While potentially useful in manufacturing individual antennas, the method is limited in that there is no true barrier to attack of the foam surface by process chemistries (both aqueous and organic) typical of printed wiring board manufacturing processes once the copper has been etched away. This results in degradation of and/or inconsistency in electrical properties and performance. This method cannot be used the high volume continuous manufacture necessary to produce a product economically.

Other problems also arise during manufacture. It was attempted to resolve the issue of degraded electrical performance by using a polyurethane film adhesive to bond copper foil directly to a rigid Baltek polystyrene foam core at 350° F., but doing so led to the partial structural collapse of the foam and did not result in an impermeable barrier between the copper and the foam. The resultant product had pinholes in the film/bonding layer, which resulted in the penetration of etch chemicals during processing. Another attempt was to coat the foam itself with a ceramic-filled resin system known to have good electrical properties. Again the foam collapsed due to heat and pressure, resulting in a material that was too dense and the seal between the copper and the foam was still inadequate to eliminate etchant penetration and entrapment in the foam structure. Other composites have been investigated, such as polyethylenes in closed and open cell forms, fut the material structure and integrity was compromised.

There is a need for a dielectric material that has characteristics such as a low dielectric constant or low loss tangent, or both, or the ability to withstand a wide range of temperatures, or to operate in wide range of atmospheric conditions and pressures, or that is capable of being used in the manufacture of composite structures that can be used alone or in combination with other materials. Such completed assemblies could form electronic components used in electronic devices.

### SUMMARY OF THE INVENTION

The present invention comprises methods and compositions for dielectric materials that are useful in laminate structures, components, or assemblies of multiple components that are useful for a variety of electronic applications. The dielectric materials of the present invention have low dielectric constant or low loss tangent, or both, can withstand a wide range of temperatures, from both high temperatures of approximately +260° C. to low temperatures of approximately −200° C., operate in wide range of atmospheric conditions and pressures, such as a high atmosphere, low vacuum such as those found in outerspace as well as at sea level or below sea level, and may comprise a material that exhibits low moisture absorption, low z-axis coefficient of thermal expansion (CTE) which may aid in the reliability of registration of through holes, excellent dimensional stability in the X and Y CTE and a low tensile modulus and are used in the manufacture of composite structures that can be used alone or in combination with other materials, thus making the present invention suitable for use in a variety of electronic applications. In addition, the dielectric material, laminates made therefrom and assemblies incorporating such dielectric materials are resistant to attack by acidic aqueous media, basic aqueous media and/or organic media, making it possible to subject such assemblies to a variety of processing conditions commonly used in printed circuit board manufacturing, such as, for example, chemical etching to introduce circuitry thereto, as well as permitting operation in harsh environments of such articles incorporating the dielectric materials.

### DETAILED DESCRIPTION

The present invention comprises methods and compositions for making and using materials having a low dielectric constant or a low loss tangent, or both. The materials of the present invention can be used in harsh environments, such environments may have temperatures of approximately +260° C. to approximately −200° C., or may have wide ranges of atmospheric conditions and pressures, such as under high atmospheric pressures to low vacuums such as those found in outer space as well as at sea level or below sea level. The materials of the present invention may be used in the manufacture of composite structures that can be used alone or in combination with other materials. As used herein, the materials of the present invention are referred to as “low dielectric materials”, but these materials are not limited to having only that characteristic, but may have one or all of the characteristics disclosed herein.

The low dielectric materials are useful as components of laminates, wherein the low dielectric material has one or more of its surfaces, or a portion of a surface, affixed or adjacent to another material, and are also useful as a component or components of assemblies, including combinations of multiple laminate structures, or where multiple layers of low dielectric materials are used. Such laminates and assemblies are used in electronic devices and applications. Electronic devices and applications include, but are not limited to, microstrip and stripline circuits, millimeter wave applications, military radar systems, missile guidance systems, point to point digital radio antennas, antennas, and other elements of cellular and wireless technology including, but not limited to, antennas for wireless communication systems, cellular base stations, LAN systems, automotive electronics, satellite TV receivers, microwave and RF components, radar systems, mobile communications systems, microwave test equipment, phase array antennas, ground based and airborne radar systems, power backplates, high reliability multilayer circuits, commercial airline collision avoidance systems, beam forming networks, airborne or other “friend or foe” identification systems, global positioning antennas and receivers, patch antennas, space saving circuitry, and power amplifiers.

Technical requirements for materials used in high performance electronic devices and applications include glass transition temperatures, dielectric constant and loss tangent, dimensional stability, low coefficient of thermal expansion, high thermal conductivity, low z-direction expansion, the ability to withstand complex and harsh processing chemistries, and have uncomplicated processing. Different materials that make up the components of the laminates or assemblies are combined to reach specific technical requirements for the specific application. One of the materials more crucial in reaching the desired technical requirements is the dielectric material.

Many materials have been used in the electronics industry to provide dielectric materials. For example, materials made from woven or nonwoven materials that are coated with resins are known. An example of these is woven or nonwoven fiberglass, coated with PTFE, polytetrafluoroethylene, and PTFE and filled PTFE are commonly used in high performance microwave type printed wired boards. The dielectric constant of such coated materials fibers is reported to be 2.2 to 2.55 or higher if filled PTFE is used. Filled PTFE results from the addition of fillers such as ceramics, glass fibers, carbon, graphite or molybdenum disulphide to PTE.

The dielectric constant, also referred to as permittivity, Dk, or Er, is the property of a material that determines the relative speed that an electrical signal will travel in that material. Signal speed is roughly inversely proportional to the square root of the dielectric constant. A low dielectric constant will result in a high signal propagation speed and a high dielectric constant will result in a much slower signal propagation speed.

A related characteristic is the impedance of a laminate structure, such as a printed circuit board. The impedance is determined by the thickness of the laminate, which is the spacing between copper layers, and its dielectric constant. Impedance control, and impedance matching of critical linked functional modules, is especially important in high speed devices and applications. Thus, a feature of such laminates and assemblies is determined by the dielectric constant of the dielectric material, thickness and width of the metal conductor such a copper, nickel, brass and aluminum.

Related to dielectric constant (or permittivity) is dissipation factor, also known as loss, loss tangent, tan beta and other terms. This is a measure of the percentage of the total transmitted power that will be lost as power dissipates into the laminate material. Prior to the present invention, the PTFE-glass materials, PTFE materials, and PTFE materials filled with other materials such as, but not limited to, ceramics that have dielectric constants as low as 2.1, may have dissipation factor measurements or loss as low as 0.0009 and were some of the preferred materials in wide commercial use for high speed, high frequency applications including applications ranging in frequency from 1 Ghz to at or 100 Ghz.

Dielectric constants and dissipation factors are considered in making and designing electronic components, for example, for high speed digital and microwave applications. The dielectric constant or low loss, or both, are important for materials that are handling high frequency, high volume digital data. These technical characteristics of dielectric constant or dissipation factor, are also linked to impedance control, which is also a consideration factor for high speed high volume digital data transmission devices.

The dielectric materials of the present invention comprise materials that can be defined as having a low dielectric constant, or low dissipation factor, or both, and optionally can withstand a wide range of temperatures, from both high temperatures of approximately +260° C. to low temperatures of approximately −200° C., can operate in wide range of atmospheric conditions and pressures, such as a high atmosphere, low vacuum such as found in outerspace as well as at sea level or below sea level, or may optionally exhibit low moisture absorption, low z-axis coefficient of thermal expansion (CTE) which may aid in the reliability of registration of through holes, excellent dimensional stability in the X and Y CTE and a low tensile modulus, or when combined with other composite materials, result in laminates or assemblies having improved impedance control.

An aspect of the present invention comprises a dielectric material comprising a dielectric constant of greater than 1.0 and less than at least 1.9, less than 1.8, less than 1.7, less than 1.6; less than 1.5; less than 1.4; less than 1.3; less than 1.2; less than 1.1 and all ranges in between 1.0 and the dielectric constant of porous PTFE. An aspect of the dielectric material of the present invention comprises a dissipation factor or loss of less than 0.0009. An aspect of the present invention comprises a dielectric material comprising a dielectric constant of greater than 1.0 and less than at least 1.9, and a loss of less than 0.0009. The present invention comprises PTFE dielectric materials for which the dielectric constant can be controlled by manufacturing steps to be a specific dielectric constant number or within a small range of a particular number.

An embodiment of the dielectric materials of the present invention comprises a porous PTFE material or a porous PTFE material that is manufactured by a particular method to have a particular characteristic such as a particular dielectric constant. Such dielectric materials may comprise microporous polymeric material, such as PTFE, and optionally having a controlled void volume. Embodiments of the dielectric materials of the present invention comprise porous PTFE alone or porous PTFE in combination with other materials such as PTFE filled materials, PTFE film, PTFE coated glass fibers or fabric. Porous PTFE materials are known to those skilled in the art. Examples of conventional fillers for PTFE include glass fibers, carbon, graphite, bronze, stainless steel, or molybdenum disulfide. Polymeric fillers may also be used.

Methods of the present invention comprise methods of making dielectric materials wherein the dielectric constant is determined by the effects of the sintering process, the ratio of the sintered resin to virgin resin; and the amount of pressure applied during molding. Methods of making dielectric materials comprise a) sintering micron sized PTFE resin, b) blending a predetermined ratio of sintered PTFE resin with unsintered PTFE resin, also referred to herein as virgin PTFE resin; c) molding the blended ratio of sintered/unsintered PTFE resin to form a molded PTFE article; d) optionally sintering the molded PTFE blended article; and e) skiving the molded PTFE article.

Sintering is the consolidation and densification of molded polytetrafluoroethylene above its melting temperature. Typically, the sintering temperature for PTFE is within the range of 350° C. to 400° C. Before it is sintered, a PTFE preform, or unsintered molded part, is relatively soft and can be easily broken with a minimal applied force. After sintering, the molded part becomes much harder, tougher and more resilient.

In general, methods comprise porous or microporous PTFE, the terms porous and microporous are interchangeably used herein, can be made by controlled sintering of powders with a defined particle size. For example, porous PTFE of the present invention can be made with PTFE particles of from 10 microns to 300 microns, with a D50max of about 100, or other known and available PTFE resins. Methods for making PTFE films are known and generally include placing the PTFE resin particles or presintered PTFE particles in a conventional or isostatic mold under pressure and further sintering the preformed billet to form a product material which may then be skived to form a film. The molding may include preformed molding or isostatic molding. The particles may or may not be pre-sintered prior to molding.

Control of the PTFE particle size and any added fillers or other materials, pre-sintering temperature and time cycles, and molding pressure or other materials affects the physical properties of the dielectric material Selection of such manufacturing steps may be dependent on the needs of the final article, composite or laminate.

Factors that affect the dielectric constant and the dissipation factor of the dielectric materials of the present invention comprise the following. The dielectric constant and the dissipation factor may increase or decrease by the amount of sintering of the PTFE by varying the time and temperature of sintering the PTFE. A method of the present invention comprises making dielectric materials having a low dielectric constant that is greater than 1.0 and less than at least 1.9, wherein the PTFE resin is sintered for a period of time that is effective to yield the desired dielectric constant. Sintering may be carried out in ovens at about 350° C. to 450° C., for approximately 10 minutes to 10 hours. In general, the more sintering the PTFE undergoes, the lower the dielectric constant the final dielectric material may have.

Another factor that may control the dielectric constant is the ratio of sintered PTFE to unsintered PTFE. The unsintered or virgin miconized PTFE may be the same size range or a different size range as the sintered PTFE. For example, the unsintered or virgin miconized PTFE may be from 5 to 300 microns, from 20 to 250 microns, or may have a D50 max of 20 microns, of 50 microns or other known and available ranges. The ratio may be from 100:0 or from 0:100, sintered PTFE:unsintered PTFE, 50:50; 75:25; 85;15; 95:5; 25:75; 15:85; 5:95; 60:40; 70:30; 90:10; 80:20; and all ratios in between. In general, the more sintered PTFE in the ratio, the lower the dielectric constant the final dielectric material may have.

Another factor that may control the dielectric constant is the mold pressure. The molding of the PTFE can be in any known molding means, including, but not limited to billeting or isostatic molding wherein the pressures may be from 25 Kg/cm² to 1000 Kg/cm² from 50 Kg/cm² to 500 Kg/cm², from 100 Kg/cm² to 300 Kg/cm², from 200 Kg/cm² to 1000 Kg/cm², from 25 Kg/cm² to 200 Kg/cm², and from 500 Kg/cm² to 1000 Kg/cm². In general, the lower the molding pressure, the lower the dielectric constant.

A factor that may control the above factors is the final product and the desired physical properties of the final product. For example, after molding, the dielectric material may be skived and may have to have the physical integrity to be skived. Thus molding pressure may have to be increased so that the material is sufficiently strong, other factors would need to be adjusted to keep the dielectric constant at the desired low number. It is the cumulative nature of the properties and the interaction of factors that allows for the adjustments in the factors to reach the desired predetermined low dielectric constant in the dielectric materials. For example, having a higher ratio of virgin PTFE allows for greater physical integrity in the finished dielectric material, but also a higher dielectric constant than a material made with a lower ratio of virgin PTFE.

The dielectric materials, having a dielectric constant of more than 1,0 and less than 1.9, or a loss of less than 0.0009, or both, are used in composite assemblies. The dielectric material may be used in an individual layer form, may be covered on one or more surfaces by a polymeric membrane, such as PFA (perfluoroalkoxy), ECTFE (ethylene chlorotrifluoroethylene), or FEP (fluoroethylene propylene), or others, or may be used in multiple layers of dielectric materials of the same or different types of polymeric materials. Any of these dielectric material combinations may be used in combination with one or more layers of conductive material such as 17 to 70 μm rolled or electrodeposited copper, copper foil or aluminum or brass or other conductors to form assemblies such as circuit boards.

The thickness of the dielectric layer can vary widely, depending on the application. For example, the dielectric material may range from 0.00001 mm to 100 mm. Those of skill in the art can readily determine suitable thickness of the dielectric material needed, depending on the end use intended for the resulting assembly.

The size of the void volume of the microporous polymeric dielectric material of the present invention can be controlled and can also vary. The void volume of the dielectric material relates to the density of the polymeric dielectric material. The void volume may correlate with Dk and Df properties in an inverse relationship. The void volume of the materials of the present invention may range from about 10% to about 75%. The preferred void volume can vary, depending on the end use intended for the dielectric material or the assembly made therefrom. For example, when one or more through-holes are drilled through or partially through an assembly, a microporous open cell material with less void volume may or may not be preferred.

An example of an assembly of the present invention comprises a layer of the dielectric material of the invention as described above, in combination with at least a second layer of material. For example a laminate comprises a first layer of a conductive material, in contact with a layer of the dielectric material having a dielectric constant of more than 1.0 and less than 1.9, or a loss tangent of less than 0.0009, or both, and optionally, the dielectric layer is in contact with one or more layers of a conductive material. Such a construct may comprise sandwiching the dielectric material between additional polymeric layers as well as the conductive layers. A laminate may also include other layers, such as a layer of material that is hydrophobic and impervious to other chemistries used in manufacture of circuits. Such a hydrophobic layer may be placed between a dielectric layer and one or more of the conductive layers. The layers may be attached to one another by methods known to those skilled in the art, including, but not limited to, adhesive means or using cofluoropolymers such as FEP as an adhesive layer. Assemblies of the present invention also contemplate combinations of multiple layers. An example of an assembly is a printed circuit board or a printed wire board.

Conductive layers contemplated for use in the practice of the present invention are typically electrically conductive, although non-conductive layers can also be employed in the practice of the present invention. Exemplary electrically conductive layers include copper or an alloy thereof, nickel or an alloy thereof, nickel or nickel alloy plated copper, rolled copper-invar-copper, aluminum, and the like, as well as combinations of any two or more thereof.

For example, the first electrically conductive layer may be copper or an alloy thereof. Similarly, the optional second electrically conductive layer, may be copper or an alloy thereof, or may be a different conductive material, or a non-conductive material.

An aspect of the present invention comprises an assembly wherein the first electrically conductive layer is capable of being converted into frequency dependent circuitry. This can be accomplished employing standard methodology. An aspect of the present invention is that an assembly can be subjected to conventional processing conditions for the preparation of circuitry thereon. Further, the second electrically conductive layer may be formed into a second frequency dependent circuit element, or it may be left intact to define a ground plane. This also can be prepared employing standard methodology.

The dielectric materials contemplated for use in the practice of the present invention, including but not limited to porous PTFE, are resistant to such exposure as acidic aqueous media, basic aqueous media, and/or organic media such as are typical in the manufacture of etched printed circuits. Such materials may be hydrophilic or hydrophobic. After drilling through holes in an assembly, the hydrophobic nature of the material can be made hydrophilic by exposure to sodium based chemistry such as FluoroEtch®, or gases such as helium, nitrogen, or hydrogen, in order to plate the through holes with a conductor such as copper. As readily recognized by those of skill in the art, a variety of media are commonly employed for the preparation and processing of electronic circuitry. Such media include, for example, acidic aqueous media (which embraces aqueous solutions having a pH of less than 7, to a pH of about 1 or less), basic aqueous media (which embraces aqueous solutions having a pH of greater than 7, to about 13 or higher), and organic media (which embraces non-polar organic solvents such as hydrocarbons, aromatics, and the like, polar organic solvents such as esters, halogenated hydrocarbons, and the like).

The dielectric materials and assemblies taught herein can be used in any electronic device or component. Applications include high frequency applications where low loss and controlled dielectric constant are required, such, but not limited to filters, couplers, low noise amplifiers, power dividers, and combiners, and applications for low cost, light weight printed circuits are used, such as printed circuit antennas for cellular infrastructure, automotive radar and other microwave and R/F applications. Electronic components or devices include precision instrumentation, electronic components and computer applications of all types, and applications including, but not limited to, circuitry components for electronic applications, telephony, radiofrequencies, microwave or other signal transmission in computers, telephones, electronic devices and components used in engines, automobiles, space craft, marine craft, medical equipments, pipelines, and transmission and monitoring devices, including but not limited to, microstrip and stripline circuits, millimeter wave applications, military radar systems, missile guidance systems, point to point digital radio antennas, antennas, and other elements of cellular and wireless technology including, but not limited to, antennas for wireless communication systems, cellular base stations, LAN systems, automotive electronics, satellite TV receivers, microwave and RF components, radar systems, mobile communications systems, microwave test equipment, phase array antennas, ground based and airborne radar systems, power backplates, high reliability multilayer circuits, commercial airline collision avoidance systems, beam forming networks, airborne or other “friend or foe” identification systems, global positioning antennas and receivers, patch antennas, space saving circuitry, and power amplifiers. The dielectric material of the present invention provides for electronic components or devices having lower impedance than is currently available because of the low dielectric constant or the low loss factor or both of the dielectric material. The dielectric material of the present invention is particularly suited to applications wherein closed cell polymeric foams are not suited.

In accordance with another aspect of the present invention, there are provided methods for the production of multiple circuits on a single large sheet of invention assembly. This is accomplished by creating a plurality of circuits by a so-called “Step and Repeat” photoimaging process on the first conductive layer of an invention assembly.

As readily recognized by those of skill in the art, assemblies can be applied to any of a variety of substrates for use. For example, circuits produced employing assemblies can be mounted on support structures, such as aluminum or composite materials intended as stiffeners, or the like, or can be combined with covers that act as protection from weather, for instance.

In accordance with yet another aspect of the present invention, there are provided multilayer assemblies comprising a plurality of the above-described assemblies of the invention. As readily recognized by those of skill in the art, a “plurality” of assemblies embraces stacking 2 up to greater than about 20 assemblies to produce complex interconnected circuitry. Optionally, such stacked assemblies may be internally interconnected by one or more through-holes.

Whereas this invention has been described in detail with particular reference to preferred embodiments, it is understood that variations and modifications can be effected within the spirit and scope of the invention, as described herein before and as defined in the appended claims. The corresponding structures, materials, acts, and equivalents of all means plus function elements, if any, in the claims below are intended to include any structure, material, or acts for performing the functions in combination with other claimed elements as specifically claimed. All patents, patent application, and references are herein incorporated in their entireties.

### EXAMPLE

### Example 1

### Making a Dieletric Material

Micronized PTFE with a D50 max 100 is sintered for 30 minutes in an oven at 375° C. The sintered PTFE is blended with in a 90:10 ratio with virgin PTFE and placed in a billet mold. The billet is molded at a pressure of 200 KG/cm². The molded article is then sintered for 8 hours at 350° C. The sintered molded articled is skived. The skived article is tested and the dielectric constant is 1.5±0.2. The article formed a flat film-like article that skived well and maintained its physical integrity. The dielectric material could be used in circuit boards, insulators, radar, microwave, components or other applications.

What is claimed is:

1. A low dielectric constant material, comprising a dielectric constant of more than 1.0 and less than 1.9, wherein the dielectric constant of the material is determined by the combined effects of the sintering process on the PTFE resin, the ratio of the sintered PTFE resin to virgin PTFE resin; and the molding pressure in the manufacturing process.

2. The material of claim 1, wherein a second sintering step is optionally performed in the manufacturing process.

3. The material of claim 1, wherein the material has a low loss tangent.

4. The material of claim 3, wherein the low loss tangent is at least 0.0009.

5. The material of claim 1, wherein the material operates in a wide range of temperatures, from both high temperatures of approximately +260° C. to low temperatures of approximately −200° C.

6. The material of claim 1, wherein the material operates in wide range of atmospheric conditions and pressures, from a high atmosphere to sea level to low vacuum such as those found in outer space.

7. The material of claim 1, wherein the material has low moisture absorption.

8. The material of claim 1, wherein the material has a low z-axis coefficient of thermal expansion (CTE).

9. The material of claim 1, wherein the material has dimensional stability in the X and Y CTE.

10. The material of claim 1, wherein the material has a low tensile modulus.

11. The material of claim 1, wherein the material is resistant to attack by acidic aqueous media, basic aqueous media or organic media.

12. The material of claim 1, wherein the material is a component of an assembly, a laminate, a component in a combination of multiple laminate structures, in electronic devices, microstrip and stripline circuits, millimeter wave applications, military radar systems, missile guidance systems, point to point digital radio antennas, antennas, and other elements of cellular and wireless technology including, but not limited to, antennas for wireless communication systems, cellular base stations, LAN systems, automotive electronics, satellite TV receivers, microwave and RF components, radar systems, mobile communications systems, microwave test equipment, phase array antennas, ground based and airborne radar systems, power backplates, high reliability multilayer circuits, commercial airline collision avoidance systems, beam forming networks, airborne or other “friend or foe” identification systems, global positioning antennas and receivers, patch antennas, space saving circuitry, and power amplifiers.

13. A method for making a dielectric material having a predetermined low dielectric constant comprising, a) sintering micron sized PTFE resin for an effective amount of time at an effective temperature; b) blending a predetermined ratio of unsintered micron sized PTFE resin with the sintered PTFE; c) molding the blended ratio of sintered/unsintered PTFE resin to form a molded PTFE article; and d) skiving the molded PTFE article to form a dielectric material.

14. The method of claim 13, comprising a further step before d), optionally sintering the molded PTFE blended article.

15. The method of claim 13, wherein the dielectric material comprises a dielectric constant of greater than 1.0 and less than at least 1.9, and a loss of less than 0.0009.

16. The method of claim 13, wherein the sintering temperature is from 350° C. to 400° C. for 10 minutes to 10 hours.

17. The method of claim 13, wherein the dielectric material is used in filters, couplers, low noise amplifiers, power dividers, and combiners, and applications for low cost, light weight printed circuits are used, such as printed circuit antennas for cellular infrastructure, automotive radar and other microwave and R/F applications. Electronic components or devices include precision instrumentation, electronic components and computer applications of all types, and applications including, but not limited to, circuitry components for electronic applications, telephony, radiofrequencies, microwave or other signal transmission in computers, telephones, electronic devices and components used in engines, automobiles, space craft, marine craft, medical equipments, pipelines, and transmission and monitoring devices, including but not limited to, microstrip and stripline circuits, millimeter wave applications, military radar systems, missile guidance systems, point to point digital radio antennas, antennas, and other elements of cellular and wireless technology including, but not limited to, antennas for wireless communication systems, cellular base stations, LAN systems, automotive electronics, satellite TV receivers, microwave and RF components, radar systems, mobile communications systems, microwave test equipment, phase array antennas, ground based and airborne radar systems, power backplates, high reliability multilayer circuits, commercial airline collision avoidance systems, beam forming networks, airborne or other “friend or foe” identification systems, global positioning antennas and receivers, patch antennas, space saving circuitry, or power amplifiers.

18. A method of using a low dielectric material, comprising, combining a low dielectric material, comprising PTFE with a dielectric constant of greater than 1.0 and less than at least 1.9, in a component or laminate system.

19. The method of claim 18, wherein the low dielectric material is made by the process of a) sintering micron sized PTFE resin for an effective amount of time at an effective temperature; b) blending a predetermined ratio of unsintered micron sized PTFE resin with the sintered PTFE; c) molding the blended ratio of sintered/unsintered PTFE resin to form a molded PTFE article; and d) skiving the molded PTFE article to form a dielectric material.

20. The method of claim 18, wherein the low dielectric material is combined to form filters, couplers, low noise amplifiers, power dividers, and combiners, and applications for low cost, light weight printed circuits are used, such as printed circuit antennas for cellular infrastructure, automotive radar and other microwave and R/F applications. Electronic components or devices include precision instrumentation, electronic components and computer applications of all types, and applications including, but not limited to, circuitry components for electronic applications, telephony, radiofrequencies, microwave or other signal transmission in computers, telephones, electronic devices and components used in engines, automobiles, space craft, marine craft, medical equipments, pipelines, and transmission and monitoring devices, including but not limited to, microstrip and stripline circuits, millimeter wave applications, military radar systems, missile guidance systems, point to point digital radio antennas, antennas, and other elements of cellular and wireless technology including, but not limited to, antennas for wireless communication systems, cellular base stations, LAN systems, automotive electronics, satellite TV receivers, microwave and RF components, radar systems, mobile communications systems, microwave test equipment, phase array antennas, ground based and airborne radar systems, power backplates, high reliability multilayer circuits, commercial airline collision avoidance systems, beam forming networks, airborne or other “friend or foe” identification systems, global positioning antennas and receivers, patch antennas, space saving circuitry, or power amplifiers.
